(19) United States
(12) Patent Application Publication
(10) Pub. No.: US 2026/0163615 A1
(43) Pub. Date: Jun. 11, 2026

(54) INTERFERENCE SUPPRESSION METHODS FOR MULTI-ANTENNA 5G AEROMACS TO FIXED SATELLITE SERVICE (FSS) SYSTEMS

(71) Applicant: BEIHANG UNIVERSITY, Beijing (CN)

(72) Inventors: Jingjing ZHAO, Beijing (CN); Kaiquan CAI, Beijing (CN); Jing SU, Beijing (CN); Yanbo ZHU, Beijing (CN); Quan ZHOU, Beijing (CN)

(73) Assignee: BEIHANG UNIVERSITY, Beijing (CN)

(21) Appl. No.: 19/280,094

(22) Filed: Jul. 24, 2025

(30) Foreign Application Priority Data
Dec. 6, 2024 (CN) 202411783239.0

(51) Int. Cl. H04B 7/0426; H04B 7/06; H04B 7/08; H04B 17/391

(52) U.S. Cl. CPC H04B 7/043; H04B 7/0686; H04B 7/0854; H04B 17/3913

(57) ABSTRACT

An interference suppression method for a multi-antenna 5G AeroMACS to an FSS system is provided, which belongs to the field of wireless communication technology. Embodiments of the present disclosure take a G2A channel matrix as an input, adaptively map the G2A channel matrix to a hybrid beamforming weight matrix and take the hybrid beamforming weight matrix as an output. At the same time, a data-driven GAN-GRU-based G2A channel matrix prediction manner is designed, and an interference suppression manner based on AO HBF is proposed to achieve accurate hybrid beamforming.

### CROSS-REFERENCE TO RELATED APPLICATIONS

This application claims priority to Chinese Patent Application No. 202411783239.0, filed Dec. 6, 2024, the entire contents of which are incorporated herein by reference.

### TECHNICAL FIELD

The present disclosure relates to the field of wireless communication technology, and in particular, to an interference suppression method for a multi-antenna 5G AeroMACS to an FSS system.

### BACKGROUND

Typically, the 5091-5150 MHz frequency band is used for airport ground 5G aeronautical mobile airport communications system (AeroMACS) networks to provide efficient wireless communication rates. However, the frequency band is also allocated for uplinks to a fixed satellite service (FSS) system for non-geostationary satellites. In other words, there is FSS radio frequency (RF) interference when the AeroMACS network coexists with the FSS system. In order to achieve the goal of spectral compatibility of the airport field, it is necessary to make an interference threshold not to exceed 2% of the equivalent noise value of an FSS satellite receiver.

To address the problem of interference to the satellite FSS system caused by ground to air (G2A) transmissions, multiple-input multiple-output (MIMO) technology utilizes directional beams to adaptively protect the communication system from interference. However, MIMO interference suppression remains a challenging problem under rapidly varying airport field communication channel conditions. Firstly, the frequent changes in channel characteristics for airport field channels require constant transmission of pilot signals for real-time channel estimation, which generates unsustainable pilot overhead and significantly reduces communication efficiency. Secondly, the beamforming matrix should be updated with the coherence time-determined channel variations, which requires beamforming techniques for interference suppression to be realized with relatively low computational complexity. Therefore, it is crucial to design a time-efficient MIMO interference suppression scheme to improve transmission reliability in rapidly-varying channel environments.

Channel estimation and beamforming are two key aspects in MIMO interference suppression techniques. Existing pilot-based channel estimation algorithms, such as least squares (LS) and minimum mean square error (MMSE), lead to a large pilot overhead providing accurate channel estimation. Additionally, blind channel estimation-based algorithms, although not requiring pilot signals, need to estimate the channel through the decomposition of the signal subspace and the noise subspace, which often leads to higher computational complexity. Based on the channel estimation, the MIMO hybrid beamforming (HBF) technique may be utilized for interference suppression and enhancement of the desired signal strength at the receiver. HBF combines the advantages of analog beamforming and digital beamforming to provide near fully-digital beamforming performance while reducing the number of RF chains. However, most of the existing research has mainly focused on applications in static scenarios without fully considering interference suppression in high-mobility scenarios.

Therefore, it is necessary to provide a multi-antenna 5G AeroMACS interference suppression method to an FSS system to address the above problems. The method designs an alternating optimization (AO) HBF interference suppression model, where the G2A channel matrix is taken as an input and adaptively mapped to the HBF weight matrix and used as an output. The proposed data-driven generative adversarial networks-gated recurrent unit (GAN-GRU) G2A channel matrix prediction algorithm achieves accurate prediction accuracy, and the proposed alternating optimization hybrid beamforming (AO HBF) interference suppression method achieves a low mean squared error (MSE) and accurate beamforming.

### SUMMARY

In view of the above problems, embodiments of the present disclosure provide an interference suppression method for a multi-antenna 5G AeroMACS to an FSS system. Firstly, the G2A channel matrix is tracked by a data-driven GAN-GRU manner. Secondly, the AeroMACS interference to the FSS system is reduced by the interference suppression manner of AO HBF. Finally, the method proposed in the embodiments of the present disclosure is verified in the rapidly-varying channel scenario of an airport field, and accurate prediction results are obtained with an insufficient count of samples of historical G2A channel matrix and low accuracy. Under the premise of satisfying the constraints on the satellite receiver under a maximum interference power constraint, the accurate beamforming and spectral compatibility effects are achieved.

One or more embodiments of the present disclosure provide an interference suppression method for a multi-antenna 5G AeroMACS to an FSS system. The method may include constructing a minimum mean square error problem at a receiver under a maximum interference power constraint, constructing a GAN-GRU-based G2A channel matrix prediction model, obtaining a predicted G2A channel matrix by using the GAN-GRU-based G2A channel matrix prediction model, constructing an AO HBF-based interference suppression model based on the predicted G2A channel matrix, obtaining an anti-interference hybrid beamforming by using the AO HBF-based interference suppression model, and reducing interference to the FSS system using the anti-interference hybrid beamforming.

In some embodiments, the process of constructing the minimum mean square error problem at the receiver under the maximum interference power constraint may include constructing a received signal model at an aircraft (AC) terminal of a subcarrier in a data transmission stage, the received signal model including a G2A GS-AC channel matrix of the subcarrier, a baseband precoding matrix of the subcarrier at a ground station (GS) terminal, a radio frequency (RF) precoding matrix at the GS terminal, a baseband combining matrix of the subcarrier at the AC terminal, and an RF combining matrix at the AC terminal, and constructing an MSE model based on the received signal model at the AC terminal of the subcarrier in the data transmission stage.

In some embodiments, the GAN-GRU-based G2A channel matrix prediction model may include a GAN-based G2A channel data enhancement module and a GRU-based channel prediction module.

In some embodiments, the GAN-based G2A channel data enhancement module may include a GAN input layer, a generative model, a discriminative model, a training model, and an evaluation model.

In some embodiments, the GRU-based channel prediction module may include a GRU input layer, a GRU unit, and an output layer.

In some embodiments, the method may include training the GAN-GRU-based G2A channel matrix prediction model by minimizing a loss function [symbol] _{GAN-GRU} of the GAN-GRU-based G2A channel matrix prediction model. An expression of the loss function may be:

$${ℒ}_{GAN - GRU} = 𝔼 \{ \frac{{\sum }_{t = 1}^{L} {‖ {\hat{H}}_{BA}^{t} - {H}_{BA}^{t} ‖}^{2}}{{\sum }_{t = 1}^{L} {‖ {H}_{BA}^{t} ‖}^{2}} \} ,$$

$${\hat{H}}_{BA}^{t}$$

denotes a predicted G2A channel matrix for a t-th frame of the GAN-GRU-based G2A channel matrix prediction model,

$${H}_{BA}^{t}$$

denotes a simulated G2A channel matrix for the t-th frame, [symbol] denotes a mean value symbol, and L denotes a total count of frames.

In some embodiments, the AO HBF-based interference suppression model may include an RF precoder, a baseband precoder, an RF combiner, and a baseband combiner.

The embodiments of the present disclosure include but are not limited to the following beneficial effects.

First, the GAN-GRU G2A channel matrix prediction method in the embodiments of the present disclosure enables G2A channel data enhancement to improve the G2A channel matrix prediction accuracy for a plurality of future frame lengths when the count of historical G2A channel matrix samples is insufficient, and the accuracy is low.

Second, under the premise of satisfying the constraint that the interference to the satellite does not exceed the maximum power, the spectrum compatibility scheme obtained in the embodiments of the present disclosure realizes the joint transceiver hybrid beamforming using the AO algorithm. Thus, the interference to the FSS system can be reduced.

Third, the AO HBF interference suppression manner proposed in the embodiments of the present disclosure uses the manifold optimization (MO) algorithm to solve the RF precoder and RF combiner constant modulus constraints.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a flowchart illustrating an exemplary interference suppression method for a multi-antenna 5G AeroMACS to an FSS system according to some embodiments of the present disclosure;

FIG. 2 is a schematic diagram illustrating an exemplary GAN-GRU G2A channel matrix prediction according to some embodiments of the present disclosure;

FIG. 3 is a schematic diagram illustrating a structure of an AO HBF interference suppression model according to some embodiments of the present disclosure;

FIG. 4 is a schematic diagram illustrating an exemplary process of obtaining a G2A channel matrix according to some embodiments of the present disclosure; and

FIG. 5 is a schematic diagram illustrating an exemplary process of constructing an AO HBF-based interference suppression model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

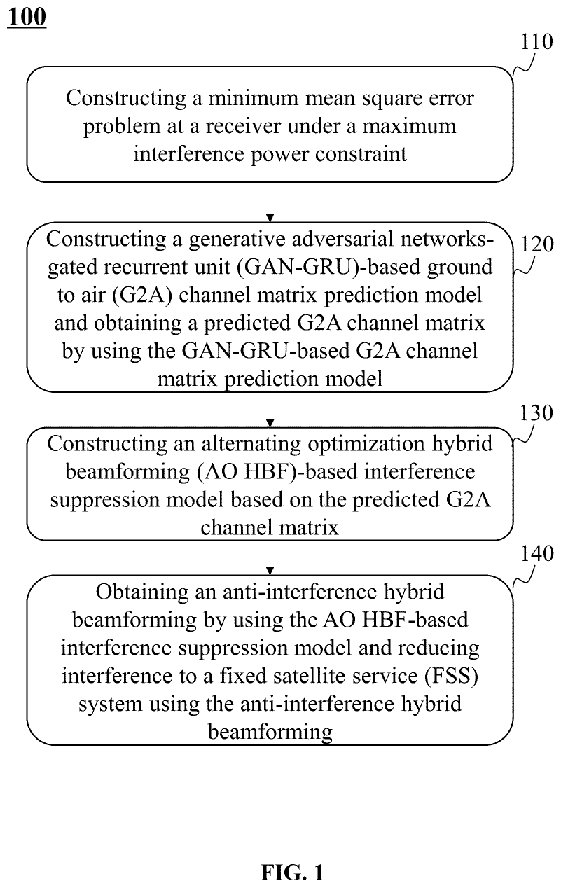

FIG. 1 is a flowchart illustrating an exemplary interference suppression method for a multi-antenna 5G AeroMACS to an FSS system according to some embodiments of the present disclosure.

Embodiments of the present disclosure provide an interference suppression method for a multi-antenna 5G AeroMACS to the FSS system. In some embodiments, process 100 may be performed by a processor.

The processor may be configured to process data and/or information obtained from other devices/components or parts. The processor may execute program instructions based on the data, information, and/or processing results to perform one or more of the functions described in the embodiments of the present disclosure. In some embodiments, the processor may include one or more sub-processing devices (e.g., a single-core processing device or a multi-core processing device). Merely by way of example, the processor may include but is not limited to, a central processing unit (CPU), a microprocessor MCU, or the like, or any combination thereof. In some embodiments, the processor may include a plurality of modules, and different modules may be configured to execute separate program instructions.

As shown in FIG. 1, process 100 includes the following operations.

In 110, a minimum mean square error problem at a receiver under a maximum interference power constraint is constructed.

Some embodiments of the present disclosure contemplate a forward link transmission of a G2A wideband MIMO system as a communication with a rapidly-varying channel, where the G2A wideband MIMO system consists of a ground station (GS) with a count of antennas of K_{B} and an aircraft (AC) with a count of antennas of K_{A}.

In order to save costs, both the ground station GS and the aircraft AC use uniform planar array (UPA) formation of antenna units and HBF architecture. The ground station GS uses an orthogonal frequency division multiplexing (OFDM) communication scheme to transmit independent data streams on X subcarriers. The signal vector transmitted on the x-th subcarrier is denoted as sₓ, and sₓ∈ [symbol] ^{N}^{ₛ}, satisfying

$$𝔼 [ {s}_{x} {s}_{x}^{H} ] = {I}_{{N}_{s}} .$$

[symbol]

^{N}^{ₛ} denotes that the signal vector sₓ belongs to the complex vector space of Nₛ dimension, and

$${s}_{x}^{H}$$

denotes the conjugate transpose of the signal vector sₓ. The equation

$$𝔼 [ {s}_{x} {s}_{x}^{H} ] = {I}_{{N}_{s}}$$

indicates that the autocorrelation matrix of the signal vector sₓ is an identity matrix of Nₛ×Nₛ. The count of data streams transmitted on each subcarrier Nₛ ensures that the communication is effective and

$${N}_{s} \leq min \{ {K}_{RF}^{B} , {K}_{RF}^{A} \} , where {K}_{RF}^{B} and {K}_{R F}^{A}$$

denote a count of RF chains at the ground station GS and the aircraft AC, respectively.

The embodiment of the present disclosure considers that transmissions of G2A may interfere with low earth orbit satellite FSS systems with Kc antennas, and therefore realizes real-time tracking of the G2A channel in rapidly-varying environments, and at the same time, a hybrid beamforming scheme that satisfies the above conditions is designed to ensure that an interference power does not exceed a specified maximum interference power threshold. The FSS system refers to a fixed satellite service system that establishes a point-to-point or point-to-multipoint radio communications service between an Earth station and a satellite.

In a communication system, a receiver refers to a device or algorithm responsible for receiving signals from a channel and detecting and decoding the signals. For example, the receiver may be a linear receiver filter, a received signal model, or the like.

An interference power constraint refers to a condition that limits the degree of the receiver amplifying an interference signal. The constraint ensures that the interference power does not exceed the limit condition to avoid serious impact of the interference on the system performance. In some embodiments, the maximum interference power constraint may be obtained directly based on the communication system.

The minimum mean square error problem refers to a problem where the goal is to minimize the MSE between an estimated signal and a true signal at the receiver. The minimum mean square error problem may be used to find an optimal receiver weight to minimize an estimation error while ensuring that the interference power does not exceed the maximum interference power constraint.

In some embodiments, the processor may construct the minimum mean square error problem based on the received signal model at the receiver.

In some embodiments, a G2A communication system (also known as a multi-antenna communication system) splits the time resource into a plurality of frames, each frame including two stages, with the two stages being a channel estimation stage and a data transmission stage.

The channel estimation stage refers to a stage of obtaining a frequency response or an impulse response of the channel in order to perform signal equalization and interference suppression in the data transmission stage. The data transmission stage refers to a stage in which the received signals are equalized and demodulated to recover the symbols of the transmitted data.

In some embodiments, for each subcarrier, the processor may construct the received signal model at an AC terminal of the subcarrier in the data transmission stage, and construct an MSE model based on the received signal model at the AC terminal of the subcarrier in the data transmission stage.

In some embodiments, the received signal model includes a G2A GS-AC channel matrix of the subcarrier, a baseband precoding matrix of the subcarrier at a GS terminal, a radio frequency (RF) precoding matrix at the GS terminal, a baseband combining matrix of the subcarrier at the AC terminal, and an RF combining matrix at the AC terminal.

In some embodiments, an expression of the received signal model is:

$${y}_{x}^{t} = {( {R}_{BB , x}^{t} )}^{H} {( {R}_{RF}^{t} )}^{H} {H}_{BA}^{x , t} {T}_{RF}^{t} {T}_{BB , x}^{t} {s}_{x}^{t} + {( {R}_{BB , x}^{t} )}^{H} {( {R}_{RF}^{t} )}^{H} {n}_{x}^{t} , where {y}_{x}^{t} \qquad ( 1 )$$

denotes the received signal for a t-th frame of the x-th subcarrier at the AC terminal;

$${R}_{BB , x}^{t}$$

denotes the baseband combining matrix for the t-th frame of the x-th subcarrier at the AC terminal;

$${R}_{RF}^{t}$$

denotes the RF combining matrix for the t-th frame at the AC terminal;

$${H}_{BA}^{x , t}$$

denotes the G2A GS-AC channel matrix for the t-th frame of the x-th subcarrier;

$${T}_{RF}^{t}$$

denotes the RF precoding matrix for the t-th frame at the GS terminal;

$${T}_{BB , x}^{t}$$

denotes the baseband precoding matrix for the t-th frame of the x-th subcarrier at the GS terminal;

$${s}_{x}^{t}$$

denotes a transmit signal vector for the t-th frame of the x-th subcarrier;

$${n}_{x}^{t}$$

denotes a zero-mean Gaussian white noise vector with a variance of σ²I_{K}_{_{A}} for the t-th frame of the x-th subcarrier, where σ² denotes a variance value of the noise, I_{K}_{_{A}} denotes an unit matrix of a size K_{A}×K_{A}; H denotes a conjugate transpose symbol.

$${T}_{BB , x}^{t} ∈ {ℂ}^{{K}_{RF}^{B} \times {N}_{s}} and {T}_{RF}^{t} ∈ {ℂ}^{{K}_{B} \times {K}_{RF}^{B}} ,$$

where [symbol] denotes a complex value, K_{B} denotes the number of antennas at und Gu, and

$${K}_{RF}^{B}$$

denotes the number of RF chains at the GS terminal of the AC.

$${R}_{BB , x}^{t} ∈ {ℂ}^{{K}_{RF}^{A} \times {N}_{s}} , {R}_{RF}^{t} ∈ {ℂ}^{{K}_{A} \times {K}_{RF}^{A}} , and {H}_{BA}^{x , t} ∈ {ℂ}^{{K}_{A} \times {K}_{B}} ,$$

where K_{A} denotes the number of antennas at the AC terminal, and

$${K}_{RF}^{A}$$

denotes the number of RF chains at the AC terminal.

$${s}_{x}^{t} ∈ {ℂ}^{{N}_{s}} , and {n}_{x}^{t} ∈ {ℂ}^{{K}_{A}} ,$$

where Nₛ denotes the number of data streams transmitted on each subcarrier.

The G2A GS-AC channel matrix denotes the G2A channel response of the subcarrier and describes channel characteristics from a GS multi-antenna to an AC multi-antenna.

The baseband precoding matrix of the subcarrier of the GS terminal refers to a matrix for precoding data symbols of the subcarrier in the baseband processing at the GS terminal to optimize the transmission performance, such as to maximize the signal-to-noise ratio or to suppress interference.

The RF precoding matrix at the GS terminal refers to a matrix that performs analog beamforming of the signal in the RF chain at the GS terminal.

The baseband combining matrix of the subcarrier at the AC terminal refers to a matrix that combines the received signals of the subcarrier in the baseband processing at the AC terminal to separate the data streams and suppress the noise/interference.

The RF combining matrix at the AC terminal refers to a matrix that performs analog beamforming of the received signal in the RF chain at the AC terminal.

In some embodiments of the present disclosure, by constructing the matrix described above, an air-to-ground (G2A) communication system with high spectral efficiency and low bit error rate may be realized.

In some embodiments, considering the propagation environment of the G2A scenario, the processor may represent the G2A GS-AC channel matrix for the t-th frame of the x-th subcarrier using a geometric Saleh-Valenzuela channel model with one line of sight (LoS) path and U non-line of sight (NLoS) paths.

In some embodiments, an expression of the G2A GS-AC channel matrix is:

$${H}_{BA}^{x , t} = {α}_{x , LoS}^{t} {a}_{A} ( {ϕ}_{A , LoS}^{azi , t} , {ϕ}_{A , LoS}^{ele , t} ) {a}_{B}^{H} ( {ϕ}_{B , LoS}^{azi , t} , {ϕ}_{B , LoS}^{ele , t} ) + \sqrt{\frac{1}{U {ρ}_{R}}} {\sum }_{u = 1}^{U} {α}_{x , u}^{t} {a}_{A} ( {ϕ}_{A , u}^{azi , t} , {ϕ}_{A , u}^{ele , t} ) {a}_{B}^{H} ( {ϕ}_{B , u}^{azi , t} , {ϕ}_{B , u}^{ele , t} ) , \qquad ( 2 )$$

where a_{B}(⋅) and a_{A}(⋅) denote a array response vector of an angle of departure (AOD) at the GS terminal and an array response vector of an angle of arrival (AOA) at the AC terminal, respectively,

$${a}_{B}^{H} ( \cdot ) ∈ {ℂ}^{1 \times {K}_{B}} , {a}_{A} ( \cdot ) ∈ {ℂ}^{{K}_{A} \times 1} ,$$

the conjugate transpose

$${a}_{B}^{H} ( \cdot )$$

or the array response vector of the angle of departure at the GS terminal belongs to a complex vector space of 1×Nₛ dimension, while the array response vector a_{A}(⋅) of the angle of arrival at the AC terminal belongs to a complex vector space of Nₛ dimension.

$${ϕ}_{B , LoS}^{azi , t} , {ϕ}_{B , LoS}^{ele , t} , {ϕ}_{B , u}^{azi , t} , {ϕ}_{B , u}^{ele , t} , {ϕ}_{A , LoS}^{azi , t} , {ϕ}_{A , LoS}^{ele , t} , {ϕ}_{A , u}^{a zi , t} , and {ϕ}_{A , u}^{ele , t}$$

denotes an azimuth angle of the AOD for the LoS path at the GS terminal, an elevation angle of the AOD for the LoS path at the GS terminal, an azimuth angle of the AOD for the u-th NLOS path of the LGS terminal, an elevation angle of the AOD for the u-th NLOS path at the LGS terminal, an azimuth angle of the AOA for the LoS path at the AC terminal, an elevation angle of the AOA for the LoS path at the AC terminal, an azimuth angle of the AOA for the u-th NLOS path at the AC terminal, and an elevation angle of the AOA for the u-th NLOS path at the AC terminal, respectively.

$${α}_{x , LoS}^{t} and {α}_{x , u}^{t}$$

denote a complex gain of the LoS path and a complex gain of the u-th NLOS path for the t-th frame of the x-th subcarrier, respectively; PR denotes the Rice factor, i.e., the power ratio between the LoS path and the NLOS path; and U denotes a total number of the NLOS path.

In some embodiments, an expression of the complex gain

$${α}_{x , u}^{t}$$

of the NLoS path is:

$${α}_{x , u}^{t} = {h}_{u}^{t} {e}^{- j 2 π \frac{x {τ}_{u}^{t}}{{T}_{s} X}} , where {h}_{u}^{t} and {τ}_{u}^{t} \qquad ( 3 )$$

denote a large-scale fading gain and a delay of the u-th NLoS path for the t-th frame, respectively; e denotes an exponent; j denotes an imaginary unit; Tₛ denotes a symbol period of OFDM; X denotes a total count of subcarriers.

In some embodiments, an expression of the complex gain

$${α}_{x , LoS}^{t}$$

of the LoS path is:

$${α}_{x , LoS}^{t} = {h}_{LoS}^{t} {e}^{- j 2 π \frac{x {τ}_{LoS}^{t}}{{T}_{s} X}} , where {h}_{LoS}^{t} and {τ}_{LoS}^{t} \qquad ( 4 )$$

denote a large-scale fading gain and a delay of the LoS path at the t-th frame, respectively.

In some embodiments, the processor may construct the MSE model with omitted frame index t based on the G2A GS-AC channel matrix

$${H}_{BA}^{x , t}$$

for the t-th frame of the x-th subcarrier, the transmit signal vector

$${s}_{x}^{t}$$

for the t-th frame of the x-th at the GS terminal, the baseband precoding matrix

$${T}_{BB , x}^{t}$$

for the t-th frame of the x-th subcarrier at the GS terminal, the RF precoding matrix

$${T}_{RF}^{t}$$

for the t-th frame at the GS terminal, and the baseband combining matrix

$${R}_{BB , x}^{t}$$

of the t-th frame of the x-th subcarrier at the AC terminal.

In some embodiments, an expression of the MSE model is:

$$\begin{matrix}MSE [ x ] = ( {‖ {s}_{x} - {β}_{x}^{- 1} {y}_{x} ‖}^{2} ) \\ = Tr ( {β}_{x}^{- 2} {R}_{x}^{H} {H}_{BA}^{x} {T}_{x} {{T}_{x}^{H} ( {H}_{BA}^{x} )}^{H} {R}_{x} \\ - {β}_{x}^{- 1} {R}_{x}^{H} {H}_{BA}^{x} {T}_{x} - {β}_{x}^{- 1} {{T}_{x}^{H} ( {H}_{BA}^{x} )}^{H} {R}_{x} \\ + {β}_{x}^{- 2} {σ}^{2} {R}_{x}^{H} {R}_{x} + {I}_{{N}_{s}} )\end{matrix} , \qquad ( 5 )$$

where MSE[x] denotes the MSE of the x-th subcarrier; [symbol] (⋅) denotes a mean square value; sₓ denotes the transmit signal vector of the x-th subcarrier at the GS terminal; yₓ denotes a receive signal vector of the x-th subcarrier at the AC terminal; βₓ denotes a scaling factor of the x-th subcarrier for a given transmission power and noise power; Tr(⋅) denotes the trace of the matrix;

$${H}_{BA}^{x}$$

denotes the G2A channel matrix of the x-th subcarrier; Tx and Rx denote a precoding matrix and a combining matrix of the GS and the AC terminal of the x-th subcarrier, respectively, Tₓ≙T_{RF}T_{BB,x}, Rₓ≙R_{RF}R_{BB,x}, T_{RF} denotes the RF precoding matrix at the GS terminal, T_{BB,x} denotes the baseband precoding matrix of the x-th subcarrier at the GS terminal, R_{RF} denotes the RF combining matrix at the AC terminal, and R_{BB,x} denotes the baseband combining matrix of the x-th subcarrier at the AC terminal; σ² denotes the variance value of the noise, I_{N}_{ₛ} denotes the unit matrix of Nₛ×Nₛ; and H denotes the conjugate transpose symbol.

In some embodiments, the processor may construct the minimum mean square error problem at the receiver under the maximum interference power constraint based on the MSE model.

In some embodiments, expressions of the minimum mean square error problem are:

$${min}_{{R}_{RF} , {R}_{BB , x} , {T}_{RF} , {T}_{BB , x} , {β}_{x}} {\sum }_{x = 0}^{X - 1} MSE [ x ] ; \qquad ( 6 a )$$

$$s . t . Tr ( {H}_{BS}^{x} {T}_{RF} {{T}_{BB , x} ( {T}_{BB , x} )}^{H} {{T}_{RF}^{H} ( {H}_{BA}^{x} )}^{H} ) \leq {P}_{thr} , ∀ x ; \qquad ( 6 b )$$

$$\vert {[ {T}_{RF} ]}_{p , q} \vert = 1 , ∀ p , q ; \qquad ( 6 c )$$

$$\vert {[ {R}_{RF} ]}_{k , l} \vert = 1 , ∀ k , l , \qquad ( 6 d )$$

where s.t. denotes the constraint symbol, T_{BB,x} denotes the baseband precoding matrix on the x-th subcarrier at the GS terminal, and T_{RF} denotes the RF precoding matrix at the GS terminal. Pₜₕᵣ denotes an interference threshold,

$${H}_{BS}^{x}$$

denotes a channel matrix of the x-th subcarrier on the GS to the satellite,

$${H}_{BS}^{x} ∈ {{K}_{C} \times {K}_{A}}^{} ; \vert {[ {T}_{RF} ]}_{p , q} \vert$$

denotes a constant modulus constraint of the RF precoding matrix T_{RF} at the GS terminal, p and q denote p-th row and q-th column element index of the RF precoding matrix T_{RF} at the GS terminal,
respectively; |[R_{RF}]_{k,l}|denotes a constant modulus constraint of the RF precoding matrix R_{RF} at the AC terminal, and k and [symbol] denote a k-th row and [symbol] -th column elements of the RF combining matrix R_{RF} at the AC terminal, respectively, and H denotes the conjugate transpose symbol.

In some embodiments, an expression of the interference threshold Pₜₕᵣ is:

$${P}_{thr} = 10 {log}_{10} ( kBTC ) , \qquad ( 7 )$$

where k=1.38×10⁻²³ J/K denotes a Boltzmann constant; B denotes a satellite receiver bandwidth; T denotes a receiver noise temperature; and C=2% denotes an interference criterion.

In embodiments of the present disclosure, the reliability of transmission under rapidly-varying channels at an airport field may be characterized by minimizing the minimum mean squared error (MMSE) between the received signal at the AC terminal and the transmitted signal at the GS terminal.

In some embodiments, the processor may randomly generate, for each region within the airport, a plurality of candidate interference thresholds at a preset interval, based on an importance level of the region, a distribution density of perceived targets, and an activity frequency of the perceived targets. The processor may evaluate a perceived accuracy of an antenna array and a stability of the FSS system under the plurality of candidate interference thresholds through an interference evaluation model based on multi-source data of the region and determine a corresponding interference threshold Pₜₕᵣ of the region based on the perceived accuracy and the stability of the plurality of candidate interference thresholds.

The preset interval may be set based on experience. For example, the preset interval may be 5 minutes, 10 minutes, or the like.

The processor may pre-divide the airport into a plurality of regions. For example, the different regions may include a terminal building, a runway area, a cargo area, a tower with an air traffic control center, or the like.

The importance level of the region refers to a value that reflects the importance of the region in the airport. The importance level of the region may be preset.

The distribution density of the perceived targets refers to an average density of the perceived targets of the antenna array in the region. The perceived target refers to a target that may be sensed by the antenna array in the region. The perceived target may include an airplane, a vehicle, a pedestrian, or the like.

The antenna array refers to a system consisting of a plurality of antenna units arranged in a particular geometric structure. The antenna array in the embodiment of the present disclosure is arranged in the airport for 5G AeroMACS.

The activity frequency of the perceived targets refers to an average count of times that the perceived targets of the antenna array appear in the region per unit of time. The processor may statistically analyze historical data to obtain the distribution density of the perceived targets and the activity frequency of the perceived targets. For example, the processor may obtain a count of the perceived targets and locations of the perceived targets at different historical moments from the historical data to determine the distribution density of the perceived targets and the activity frequency of the perceived target.

In some embodiments, for each region within the airport, the processor may determine an interference threshold range corresponding to the region based on the importance level of the region, the distribution density of the perceived targets, and the activity frequency of the perceived targets through a first preset table and randomly generate the plurality of candidate interference thresholds based on the interference threshold range.

The first preset table may include the importance level of the region, the distribution density of the perceived targets, the activity frequency of the perceived targets, and a corresponding interference threshold range. The first preset table may be set by a technician based on experience.

The multi-source data refers to data from a plurality of sources of the region. The multi-source data may include meteorological data of the airport, a distribution of electromagnetic equipment, and a distribution of the perceived targets.

The meteorological data may include a wind speed, a temperature, a humidity, or the like. The meteorological data may be obtained from weather forecasts.

The distribution of electromagnetic equipment may include the distribution of locations of radars, Internet of Things devices, or the like. The distribution of electromagnetic equipment may be obtained directly from the electromagnetic equipment.

The distribution of the perceived targets refers to a distribution of positions of the perceived targets. The distribution of the perceived targets may be obtained by the antenna array.

The perceived accuracy of the antenna array refers to the accuracy of the antenna array on the perceived target.

The stability of the FSS system refers to the stability of the FSS system communication.

In some embodiments, the interference evaluation model may be a machine learning model. For example, the interference evaluation model may be a neural network model, recurrent neural networks (RNN) model, etc.

In some embodiments, inputs of the interference evaluation model may include the multi-source data and candidate interference thresholds, and outputs of the interference evaluation model may include perceived accuracies and stabilities of the FSS system of the corresponding antenna array for the candidate interference thresholds.

In some embodiments, the interference evaluation model may be obtained by training based on training data. In some embodiments, the processor may obtain a plurality of first training sample sets consisting of first training samples with first labels.

The first training sample may include a plurality of historical interference thresholds and corresponding historical multi-source data used in the region. The first label may be the perceived accuracy and the stability of the FSS system of the antenna array corresponding to the first training sample. The processor may take the accuracy of the antenna array in detecting the perceived targets (i.e., a ratio of a count of detected perceived targets to a count of actual perceived targets) for a subsequent period of time at the historical moment corresponding to the first training sample as the perceived accuracy of the antenna array corresponding to the first training sample. The processor may also use a signal-to-noise ratio of the FSS system for the subsequent period of time at the historical moment corresponding to the first training sample as the stability of the FSS system corresponding to the first training sample.

In some embodiments, the processor may input the first training sample set into an initial interference evaluation model to perform a plurality of rounds of iterations. Each round of iteration includes selecting one or more first training samples from the first training sample set, inputting the one or more first training samples into the initial interference evaluation model, obtaining one or more model estimation output corresponding to the one or more first training samples, substituting one or more model estimation output and the first labels of the one or more first training samples into a formula of a predefined loss function to calculate a value of the loss function, and inversely updating model parameters of the initial interference evaluation model based on the value of the loss function. When an iteration end condition is satisfied, the iteration is ended to obtain the trained interference evaluation model. The iteration end condition may be that the loss function converges, the count of iterations reaches a threshold, etc.

In some embodiments, the processor may perform a normalization process on the perceived accuracy and the stability corresponding to each of the candidate interference thresholds, then perform a weighted summation, and determine the candidate interference threshold with a largest weighted sum as a final interference threshold Pₜₕᵣ. The normalization process may include a Min-Max normalization, or the like. A weight coefficient of the weighted summation may be set based on experience.

In some embodiments of the present disclosure, determining the perceived accuracy of the antenna array and the stability of the FSS system through the interference evaluation model may utilize the self-learning capability of the machine learning model to find a rule from a large amount of historical data, which improves the accuracy and efficiency of determining the interference threshold.

In 120, a GAN-GRU-based G2A channel matrix prediction model is constructed, and a predicted G2A channel matrix is obtained by using the GAN-GRU-based G2A channel matrix prediction model.

The GAN-GRU-based G2A channel matrix prediction model refers to a model that predicts a G2A channel matrix based on a prediction algorithm of GAN-GRU. In some embodiments, the GAN-GRU-based G2A channel matrix prediction model is a machine learning model.

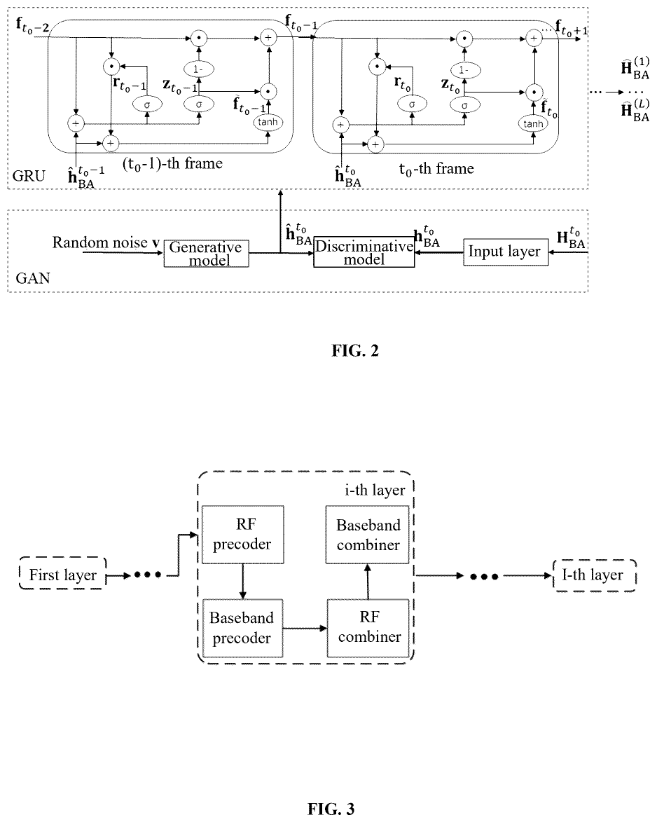

FIG. 2 is a schematic diagram illustrating an exemplary GAN-GRU G2A channel matrix prediction according to some embodiments of the present disclosure. In some embodiments, as shown in FIG. 2, the GAN-GRU-based G2A channel matrix prediction model includes a GAN-based G2A channel data enhancement module and a GRU-based channel prediction module.

The GAN-based G2A channel data enhancement module refers to a module that generates data conforming to real channel distributions through generative adversarial networks (GANs) in order to expand the training dataset and improve the generalization ability of the prediction model.

In some embodiments, a count and diversity of G2A channel datasets may be enhanced by the GAN-based G2A channel data enhancement module, and the training effect of the GRU channel prediction model may be subsequently enhanced.

In some embodiments, the GAN-based G2A channel data enhancement module includes a GAN input layer, a generative model (GM), a discriminative model (DM), a training model, and a evaluation model.

In some embodiments, the GAN input layer is configured to extract real and imaginary parts of the input data and generate a matrix vector.

In some embodiments, the processor may sample a historical real G2A channel matrix.

The GAN input layer may extract real and imaginary parts of a plurality of historical real G2A channel matrix

$${H}_{BA}^{{t}_{0}} ,$$

vectorize the extracted real and imaginary parts and concatenate into a plurality of historical real G2A channel matrix vectors

$${h}_{BA}^{{t}_{0}} .$$

In some embodiments, an expression of the historical real G2A channel matrix

$${H}_{BA}^{{t}_{0}}$$

is:

$$\begin{matrix}{H}_{BA}^{{t}_{0}} = {[ {vec ( \{ {H}_{BA}^{{t}_{0}} \} )}^{T} , {vec ( \{ {H}_{BA}^{{t}_{0}} \} )}^{T} ]}^{T} ∈ {2 {K}_{A} {K}_{B} X \times 1}^{} \\ where {H}_{BA}^{{t}_{0}}\end{matrix} , \qquad ( 8 )$$

denotes the historical real G2A channel matrix on all subcarriers for t₀-th frame; [symbol] {⋅} denotes a set of real parts; [symbol] {⋅} denotes a set of imaginary parts; vec(⋅) denotes a set of vectors; [symbol] denotes a set of real numbers; D denotes an index of the current frame; and P denotes a total count of the historical frames.

In some embodiments, the generative model is configured to generate an enhanced channel matrix.

In some embodiments, an input of the generative model may include random noise obeying a Gaussian distribution, and the generative model generates the enhanced channel matrix

$${\hat{h}}_{BA}^{{t}_{0}}$$

for the t₀-th frame similar to a real G2A channel matrix for the t₀-th frame by learning a distribution of the historical real G2A channel matrix. The random noise affects the accuracy of an output of the generative model.

In some embodiments, the processor may randomly generate random noise for different scenarios based on historical noise data of the airport and corresponding historical multi-source data and input the random noise to the GAN input layer.

In some embodiments, the historical noise data may include a noise type, a frequency-domain feature, and a time-domain feature of the historical noise of 5G AeroMACS at the airport. The noise type may include a thermal noise, an impulse noise, a phase noise, and a multipath interference, or the like. The frequency-domain feature may include an amplitude probability distribution and a pulse repetition frequency, or the like. The time-domain feature may include a power spectral density and a harmonic component, or the like.

In some embodiments, the processor may cluster the historical multi-source data and determine the plurality of clusters obtained after clustering as different scenarios. For each scenario, the processor may qualify conditions for generating the random noise based on the plurality of pieces of historical noise data corresponding to the plurality of pieces of historical multi-source data within the clustered clusters corresponding to a particular scenario, perform incomplete randomization to generate a plurality of random noises. The operation of qualifying the conditions for generating the random noise may include generating noise of a particular type, a particular range of the frequency-domain feature, and a particular range of the time-domain feature.

In some embodiments of the present disclosure, classifying the historical multi-source data and generating random noise under different scenarios based on the classified scenarios may help to make the GAN input noise more in line with the actual situation of the airport, thereby improving the accuracy and authenticity of the GAN output.

In some embodiments, the generative model includes four convolutional layers, a batch normalization (BN) layer, and a parametric rectified linear unit (ReLU) arranged in sequence. The four convolutional layers have good recognition performance for a spatio-temporal feature of the historical real G2A channel matrix. The BN layer normalizes the outputs of each node of each layer to enhance the generalization and robustness of the generative model. An activation function of the parametric ReLU is used for nonlinear processing to improve the accuracy and efficiency of training.

In some embodiments, the discriminative model is configured to output a binary classification result based on the input data. Inputs of the discriminative model include the enhanced channel matrix

$${\hat{h}}_{BA}^{{t}_{0}}$$

for each frame generated by the generative model and the historical real G2A channel matrix

$${H}_{BA}^{{t}_{0}} ,$$

an output is the binary classification result. The binary classification result includes two results of either the historical real G2A channel matrix is real, or the historical real G2A channel matrix is synthetic.

In some embodiments, the discriminative model includes five convolutional layers and one fully connected (FC) layer, with a BN layer, a ReLU layer, and a random deactivation dropout layer. The discriminative model may extract a multi-dimensional feature of the enhanced channel matrix

$${\hat{h}}_{BA}^{{t}_{0}}$$

for each frame output from we generative model, and guide a training direction of the generative model to generate a more realistic enhanced channel matrix by comparing the multi-dimensional feature to the historical real G2A channel matrix vector

$${h}_{BA}^{{t}_{0}} .$$

In the embodiment, the BN layer, the ReLU layer, and the random deactivation dropout layer are added to the discriminative model, which improves the resistance and generality of the neural network. In addition, the generative model is responsible for generating the enhanced channel matrix (also referred to as synthetic data) with a goal of making the enhanced channel matrix as close as possible to the historical real G2A channel matrix (also referred to as real data) in terms of a channel spatial-temporal feature, whereas the discriminative model learns how to differentiate between the historical real G2A channel matrix and the generated enhanced channel matrix in the course of the game.

The training model is configured to train a GAN-based G2A channel data enhancement module.

In some embodiments, the goal of training the GAN-based G2A channel data enhancement module is to minimize a loss function of the discriminative model.

In some embodiments, an expression of the loss function Loss_{DM} of the discriminative model is:

$${Loss}_{DM} = \frac{1}{r} {\sum }_{i = 1}^{r} [ log DM ( {h}_{BA , i}^{{t}_{0}} ) + log ( 1 - DM ( GM ( {v}_{i} ) ) ) ] , \qquad ( 9 )$$

where r denotes a count of training batches;

$$log DM ( {h}_{BA , i}^{{t}_{0}} )$$

denotes a judgment of the discriminative model on the enhanced channel matrix

$${\hat{h}}_{BA}^{{t}_{0}}$$

for the t₀-th frame during an i-th training, log(1−DM(GM(vᵢ))) denotes a judgment of the discriminative model on a similarity between the enhanced channel matrix generated by the generative model under the input noise vᵢ of for the t₀-th frame during the i-th training with the historical real G2A channel matrix; and vᵢ denotes the noise input into the GM of the generative model during the i-th training.

In some embodiments, the evaluation model is configured to evaluate the performance of the generative model and the discriminative model. The evaluation model evaluates the performance of the generative model and the discriminative model by testing the ability of the enhanced channel matrix

$${\hat{h}}_{BA}^{{t}_{0}}$$

(i.e., channel spatio-temporal feature) generated by the generative model and the discriminative model to be similar to the real channel.

In some embodiments, the evaluation model measures whether the enhanced channel matrix

$${\hat{h}}_{BA}^{{t}_{0}}$$

generated by the generative model and the discriminative model is similar to a simulated G2A channel matrix through an adversarial loss

$${D}_{GM}^{*} .$$

In some embodiments, an expression of the adversarial loss

$${D}_{GM}^{*}$$

is:

$${DM}_{GM}^{*} = \frac{{P}_{{h}_{BA}^{t}}}{{P}_{{\hat{h}}_{BA}^{{t}_{0}}} + {P}_{{h}_{BA}^{t}}} , \qquad ( 10 )$$

$$where {P}_{{h}_{BA}^{t}}$$

denotes a data distribution of the simulated G2A channel matrix vector

$${h}_{BA}^{t}$$

for the t-th frame;

$${P}_{{\hat{h}}_{BA}^{{t}_{0}}}$$

denotes a data distribution of the enhanced channel matrix

$${\hat{h}}_{BA}^{{t}_{0}}$$

for the t₀-th frame.

In some embodiments, when the data distribution

$${P}_{{\hat{h}}_{BA}^{{t}_{0}}}$$

of the enhanced channel matrix

$${\hat{h}}_{BA}^{{t}_{0}}$$

for the t₀-th frame is close to the data distribution

$${P}_{{h}_{BA}^{{t}_{0}}}$$

of the historical real G2A channel matrix vector

$${h}_{BA}^{{t}_{0}}$$

for the t₀-th frame, the adversarial loss

$${DM}_{GM}^{*}$$

is close to 0.5. In this case, the discriminative model is unable to distinguish between the real observed G2A channel data vector and the enhanced channel matrix. That is, the generated data may be regarded as the real G2A channel data.

In some embodiments, the GAN-based G2A channel data enhancement module further includes a feature extraction layer. The feature extraction layer is configured to perform feature extraction on the historical multi-source data. The historical multi-source data corresponds to a distribution of the GAN input layer input of the historical real G2A channel matrix. The input of the GAN input layer further includes a historical multi-source feature output by the feature extraction layer.

In some embodiments, an input of the feature extraction layer is the historical multi-source data, and an output of the feature extraction layer is the historical multi-source feature corresponding to the historical multi-source data.

The multi-source feature includes an interference type and an interference level of the multi-source data to the antenna array. The interference type may include a signal amplitude attenuation, a narrowband frequency selective attenuation, a random phase fluctuation, or the like. The interference level may include a magnitude of the signal amplitude attenuation, a magnitude of the narrowband frequency selective attenuation, and a frequency of the random phase fluctuation.

In some embodiments, the feature extraction layer may be obtained by training based on the training data. In some embodiments, the processor may obtain a plurality of second training sample sets consisting of second training samples with second labels and perform a plurality of rounds of iterations based on the second training sample sets. The training of the feature extraction layer is similar to the interference evaluation model.

The second training sample may include a plurality of sample multi-source data. The second label may be a multi-source feature corresponding to the second training sample. The processor may measure to obtain a plurality of interference types and corresponding interference levels of each of the plurality of pieces of sample multi-source data to the antenna array under test conditions of the sample multi-source data. For each type of multi-source data, the processor may separately measure and obtain the respective corresponding interference type and corresponding interference level. For example, the processor may perform an analysis (e.g., signal visualization, determining the amount of attenuation in the signal amplitude, determining whether there is attenuation and phase fluctuation at narrowband frequencies, etc.) from the signal received by the antenna array to obtain the interference level.

In some embodiments of the present disclosure, inputting the historical multi-source feature into the GAN-based G2A channel data enhancement module helps the GAN-based G2A channel data enhancement module to analyze a historical environment in which the distribution of the historical real G2A channel matrix is located, so that the output enhanced channel matrix to be more consistent with the real situation.

The GRU-based channel prediction module refers to a module that uses gated recurrent units (GRUs) to learn a spatio-temporal evolution law of the channel matrix and realize a multi-step prediction.

In some embodiments, the GRU-based channel prediction module may extract a temporal feature and a spatial feature of the G2A channel matrix (the enhanced channel matrix

$${\hat{h}}_{BA}^{{t}_{0}} )$$

generated by the GAN-based G2A channel data enhancement module and predict a future channel state.

In some embodiments, the GRU-based channel prediction module includes a GRU input layer, a GRU unit, and an output layer.

In some embodiments, the GRU input layer may input the enhanced channel matrix

$${\hat{h}}_{BA}^{{t}_{0}}$$

for the t₀-th frame generated by the GAN-based G2A channel data enhancement module and the enhanced channel matrix

$${\hat{h}}_{BA}^{{t}_{0} - 1}$$

for the t₀-1-th frame into the GRU-based channel prediction module.

In some embodiments, the GRU-based channel prediction module may use an update gate and a reset gate to control the flow of the information to capture dependency relationships between the enhanced channel matrix

$${\hat{h}}_{BA}^{{t}_{0}}$$

for the t₀-th frame, the enhanced channel matrix

$${\hat{h}}_{BA}^{{t}_{0} - 1}$$

for the t₀-1-th frame, and a plurality of enhanced channel matrices for historical frames.

In some embodiments, an update gate zₜ_{₀} for the t₀-th frame controls a count of the information being passed from the enhanced channel matrix

$${\hat{h}}_{BA}^{{t}_{0} - 1}$$

for the t₀-1-th frame to the enhanced channel matrix

$${\hat{h}}_{BA}^{{t}_{0}}$$

for the t₀-th frame. An expression of the update gate zₜ_{₀} for the t₀-th frame is:

$${z}_{{t}_{0}} = σ ( {W}_{z} \cdot [ {f}_{{t}_{0} - 1} , {\hat{h}}_{BA}^{{t}_{0}} ] ) , \qquad ( 11 )$$

where zₜ_{₀} denotes the update gate for the t₀-th frame; σ denotes the Sigmoid activation function, W_{z} denotes a weight matrix of the update gate, and fₜ_{₀}₋₁ denotes a hidden state for the t₀−1-th frame.

In some embodiments, the reset gate rₜ_{₀} for the t₀-th frame controls a count of forgets in the enhanced channel matrix

$${\hat{h}}_{BA}^{{t}_{0} - 1}$$

for the t₀−1-th frame, allowing the GAN-GRU-based G2A channel matrix prediction model to ignore unnecessary historical information and focus on important features of the enhanced channel matrix for the current frame. An expression of the reset gate rₜ_{₀} for the t₀-th frame is:

$${r}_{{t}_{0}} = σ ( {W}_{r} \cdot [ {f}_{{t}_{0} - 1} , {\hat{h}}_{BA}^{{t}_{0}} ] ) , \qquad ( 12 )$$

where rₜ_{₀} denotes the reset gate for the t₀-th frame; Wᵣ denotes the weight matrix of the reset gate.

In some embodiments, the reset gate rₜ_{₀} for the t₀-th frame stores past G2A channel matrix-related information and updates the new memory content to a candidate hidden state \tilde{f}ₜ_{₀}. An expression of the candidate hidden state \tilde{f}ₜ_{₀} for the t₀-th frame is:

$${\tilde{f}}_{t} = tanh ( W \cdot [ {r}_{{t}_{0}} * {f}_{{t}_{0} - 1} , {\hat{h}}_{BA}^{{t}_{0}} ] ) , \qquad ( 13 )$$

where tanh denotes an activation function and W denotes a weight matrix of the candidate hidden state.

In some embodiments, the hidden state for the t₀-1-th frame is fused with the candidate hidden state \tilde{f}ₜ for the t₀-th frame to obtain the hidden state fₜ of the GRU unit for the t₀-th frame. An expression of the hidden state fₜ is:

$${f}_{t} = ( 1 - {z}_{t} ) * \tilde{{f}_{t}} + {z}_{t} * {f}_{t - 1} , \qquad ( 14 )$$

In some embodiments, the output layer is configured to output a predicted channel matrix

$${\hat{h}}_{BA}^{t}$$

for each frame. By combining the real and imaginary parts of the predicted channel matrix

$${\hat{h}}_{BA}^{t}$$

for each frame, a set of prediction G2A channel matrices

$$\{ {\hat{H}}_{BA}^{1} , … , {\hat{H}}_{BA}^{L} \}$$

for an L-th frame is obtained,

$${\hat{h}}_{BA}^{t} ∈ {ℝ}^{2 \times X \times {K}_{A} \times {K}_{B}} , and {\hat{H}}_{BA}^{1} and {\hat{H}}_{BA}^{L}$$

denote the predicted G2A channel matrix for the first frame and the predicted G2A channel matrix for the L-th frame, respectively.

In some embodiments of the present disclosure, the GRU-based channel prediction module is capable of effectively extracting and utilizing the temporal feature and the spatial features of the G2A channel matrix generated by the GAN-based G2A channel data enhancement module, so as to improve the accuracy of the prediction of the future channel state (i.e., the future G2A channel matrix), reduce pilot overhead, and enhance system performance.

In some embodiments, the GAN-GRU-based G2A channel matrix prediction model is trained by minimizing a loss function [symbol] _{GAN-GRU} of the GAN-GRU-based G2A channel matrix prediction model. For example, the training is performed by minimizing the MSE between the set of predicted G2A channel matrices output by the GAN-GRU-based G2A channel matrix prediction model and the simulated G2A channel matrix.

In some embodiments, an expression of the loss function [symbol] _{GAN-GRU} is:

$${ℒ}_{GAN - GRU} = 𝔼 \{ \frac{{\sum }_{t = 1}^{L} {‖ {\hat{H}}_{BA}^{t} - {H}_{BA}^{t} ‖}^{2}}{{\sum }_{t = 1}^{L} {‖ {H}_{BA}^{t} ‖}^{2}} \} , \qquad ( 15 )$$

$$where {\hat{H}}_{B A}^{t}$$

denotes the predicted G2A channel matrix for the t-th frame of the GAN-GRU-based G2A channel matrix prediction model,

$${H}_{BA}^{t}$$

denotes the simulated G2A channel matrix for the t-th frame, [symbol] denotes a mean value symbol, and L denotes a total count of predicted frames.

In some embodiments, training the GAN-GRU-based G2A channel matrix prediction model includes the following operations.

In 1201, a training set of historical real G2A channel matrices is given, a count of training batches is set to be N, and a learning rate is set to be n.

In 1202, the real and imaginary parts of the training set of the historical real G2A channel matrices are extracted to obtain the simulated G2A channel data vector

$${h}_{BA}^{t} .$$

In 1203, the generative model generates the enhanced channel matrix

$${\hat{h}}_{BA}^{{t}_{0}} ,$$

and the discriminative model evaluates the enhanced channel matrix

$${\hat{h}}_{BA}^{{t}_{0}}$$

by using the expression (9) for the loss function; in response to determining that an evaluation result is the loss function converging, the next operation is performed; and in response to determining that the evaluation result is the loss function not converging, the weight matrix of the GAN-based G2A channel data enhancement module is updated, and operations 1202-1203 are repeated.

In 1204, the update gate retains features of the historical enhanced channel matrix to obtain the update gate zₜ_{₀} for the first t₀-th frame.

In 1205, the reset gate focuses on features of the current enhanced channel matrix to obtain the reset gate rₜ_{₀} for the t₀-th frame.

In 1206, the enhanced G2A channel matrix is output.

In 1207, the real and imaginary parts of the enhanced channel matrix are combined to obtain the predicted G2A channel matrix; in response to determining that the loss function obtained using the expression (15) converges, the next operation is performed, i.e., the trained GAN-GRU-based G2A channel matrix prediction model is obtained; in response to determining that the loss function obtained using the expression (15) does not converge, the weight matrix of the GRU-based channel prediction module is updated and operations 1204-1207 are repeated.

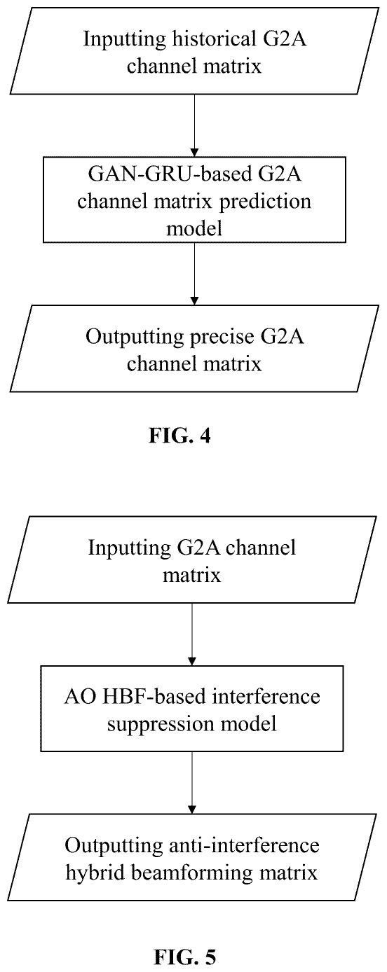

FIG. 4 is a schematic diagram illustrating an exemplary process of obtaining the G2A channel matrix according to some embodiments of the present disclosure. In some embodiments, as shown in FIG. 4, when using the trained GAN-GRU-based G2A channel matrix prediction model, the input is the historical real G2A channel matrix, and the output is the predicted G2A channel matrix.

From the MSE model in the expression (5), the MSE model may be solved only if

$${H}_{BS}^{x} and {H}_{BA}^{x}$$

are known. The present disclosure assumes that the channel matrix

$${H}_{BS}^{x}$$

from GS to the satellite (also known as a satellite-ground channel matrix) is known and focuses only on tracking the G2A channel. Observing the G2A channel matrix

$${H}_{BA}^{x}$$

under a rapidly-varying channel obviously occupies a large amount of pilot overhead, which reduces communication efficiency. In addition, since the expression (5) of the MSE model must be solved each time

$${H}_{BS}^{x} and {H}_{BA}^{x}$$

are changed, it is required that the proposed solution manner should work with relatively low computational complexity. However, the expression (5) of the MSE model is difficult to handle due to the highly coupled optimization variables and norm constraints. In order to address the above two challenges, some embodiments of the present disclosure provide a G2A channel matrix prediction strategy that utilizes a past observation set to predict the G2A channel matrix for a plurality of future frames, with low pilot overhead and high robustness. Then, the interference suppression algorithm of the AO HBF may be executed based on

$${H}_{BA}^{x} , x ∈ \{ 1 , ... , X \} ,$$

which is alternately iterated at the transmitter and receiver to achieve accurate beamforming and spectral compatibility effects.

In some embodiments of the present disclosure, manners such as interpolation or compressed sensing are used to recover the full-space observation, overcoming the problem of the interfering projection being under-ranked, brought about by the casting of a shadow space smaller than the total subcarrier space.

In some embodiments, the set of the G2A channel matrices based on the observed historical plurality of frames is

$${H}_{BA}^{{t}_{0}} .$$

Because or the high dependence on the amount of training data and the accuracy of the data when using machine learning for channel prediction, it is not possible to obtain highly accurate G2A channel data with a sufficient spatial-temporal feature when the count of samples of the channel matrix is small. Some embodiments of the present disclosure provide a GAN-GRU model to perform training data enhancement of G2A channels and thereby improve prediction accuracy to reduce the pilot overhead caused by frequent G2A channel matrix estimation. The GAN-GRU model consists of a GAN cascaded with a GRU network. The GAN generates synthetic data that is similar to the real data through adversarial learning of two sub-models, namely, the generative model and the discriminative model, in order to obtain a sufficient count of datasets, and then input the high-accuracy G2A channel dataset with the spatio-temporal feature output from the GAN into the GRU network to obtain the predicted G2A channel matrix.

In some embodiments, the joint GAN-GRU-based predictive channel model is not only capable of performing G2A channel data enhancement by GAN to generate corresponding channel datasets with the spatio-temporal feature, but also capable of extracting sequential data features by GRU and performing joint prediction in a spatio-temporal domain.

In some embodiments, for different regions within the airport at a preset interval, the processor may determine a count of pilot signals for different regions based on the importance level of the region, a region feature, and a historical prediction accuracy and control the transmitter to send the pilot signals based on the count of pilot signals.

More description regarding the different regions of the airport and the importance level of the region may be found in operation 110.

The region feature may include a region type and a region event.

In some embodiments, the region type may include different types such as a terminal building, a runway area, a cargo area, a tower with an air traffic control center, or the like.

The region event refers to an event that is occurring in the region. For example, the region event may be that there may be an airplane taking off or landing in the runway area, there may be a large shipment moving in or out of a warehouse in the cargo area, there may be passengers boarding a plane via ferry around the periphery of the terminal building, etc.

The historical prediction accuracy refers to a difference between the predicted G2A channel matrix output by the GAN-GRU-based G2A channel matrix prediction model and the real G2A channel matrix in the last preset interval. The processor may use a normalized MSE between the predicted G2A channel matrix and the real G2A channel matrix as a gap between the predicted G2A channel matrix and the real G2A channel matrix.

The count of pilot signals refers to a count of pilot signals sent by the transmitter. The pilot signal refers to a reference signal, which is sent by the transmitter, and the receiver estimates channel state information by measuring the pilot signals.

In some embodiments, in response to determining that the historical prediction accuracy is less than a preset accuracy threshold, the processor may determine the count of pilot signals corresponding to the region based on the importance level of the region, the region feature, and the historical prediction accuracy through a vector database. The preset accuracy threshold may be set based on experience.

The vector database refers to a predetermined database including a plurality of reference feature vectors and corresponding labels. The processor may construct the reference feature vector based on the importance level of the region, the region event, and the historical prediction accuracy corresponding to the historical moment in the historical data and determine the count of pilot signals corresponding to the reference feature vector as a label. The processor may determine the count of pilot signals with the least interference power in a subsequent period of time corresponding to the historical moment of the reference feature vector as a label corresponding to the reference feature vector. The interference power refers to an interference power of the 5G AeroMACS to the FSS system.

In some embodiments, the processor may construct a target feature vector based on the importance level of the region, the region feature, and the historical prediction accuracy and perform a match in the vector database to determine the count of pilot signals based on the target feature vector. The processor may search the vector database for the label corresponding to the reference feature vector that has the highest similarity (e.g., the smallest vector distance) to the target feature vector, and determine the count of pilot signals that corresponds to the target feature vector.

In an embodiment of the present disclosure, when the output accuracy of the GAN-GRU-based G2A channel matrix prediction model is relatively low, transmitting the pilot signals, and estimated channel state information corresponding to the pilot signal may be designated as a supplement data to model output to improve the accuracy of the model prediction.

In 130, an AO HBF-based interference suppression model is constructed based on the predicted G2A channel matrix.

In order to solve the minimum mean square error problem at the receiver under the maximum interference power constraint, expressions (6a)-(6d) of the minimum mean square error problem may be solved based on an idea of AO by decoupling and iteratively solving T_{BB,x}, T_{RF}, R_{RF}, and R_{BB,x} on the basis of obtaining the predicted G2A channel matrix in operation 120. The processing is layered and iterative through an external loop and an internal loop, with the external loop iterating between the precoder and combiner, and the internal loop iterating between baseband and RF processing. The present disclosure focuses on the algorithmic design of the GS terminal precoder for spectrum compatibility, and the AC terminal combiner design problem may be solved in the same way.

In some embodiments, an expression of designing a precoding design subproblem is:

$${min}_{{T}_{RF} , {T}_{BB , x} , {β}_{x}} {\sum }_{x = 0}^{X - 1} Tr ( {H}_{1}^{H} {T}_{R F} {{\tilde{T}}_{BB , x} ( {\tilde{T}}_{BB , x} )}^{H} {T}_{RF}^{H} {H}_{1} - {H}_{1}^{H} {T}_{R F} {\tilde{T}}_{BB , x} - {( {\tilde{T}}_{BB , x} )}^{H} {T}_{R F}^{H} {H}_{1} + {β}_{x}^{- 2} {{σ}^{2} ( {R}_{x} )}^{H} {R}_{x} + {I}_{{N}_{s}} ) ; \qquad ( 16 a )$$

$$s . t . Tr ( {H}_{B S}^{x} {T}_{R F} {{\tilde{T}}_{BB , x} ( {\tilde{T}}_{BB , x} )}^{H} {{T}_{R F}^{H} ( {H}_{B S}^{x} )}^{H} ) \leq {P}_{thr} , ∀ x ; \qquad ( 16 b )$$

$$\vert {[ {T}_{R F} ]}_{p , q} \vert = 1 , ∀ p , q , \qquad ( 16 c )$$

where H₁ denotes an equivalent G2A channel matrix obtained by multiplying the G2A channel matrix

$${H}_{B A}^{x}$$

of the x-the subcarrier with a combining matrix Rₓ at the AC terminal, and \tilde{T}_{BB,x denotes an equivalent baseband precoding matrix obtained by multiplying an inverse of the scaling factor}

$${β}_{x}^{- 1}$$

at the transmission power and noise power of the x-th subcarrier with the baseband precoding matrix T_{BB,x}.

In some embodiments,

$${H}_{1} {=}^{Δ} {H}_{B A}^{x} {R}_{x} , and {\tilde{T}}_{BB , x} = {β}_{x}^{- 1} {T}_{BB , x} .$$

In some embodiments, when a target function (the expression (16a)) of the precoding design subproblem is maximized with respect to the baseband combining matrix R_{BB,x}, ∀ₓ∈{1, . . . , X} of the x-th subcarrier, an expression of obtaining a value of the scaling factor βₓ for the given transmission power and noise power of the x-th subcarrier is:

$${β}_{x} = {( \frac{Tr ( {T}_{R F} {{\tilde{T}}_{BB , x} ( {\tilde{T}}_{BB , x} )}^{H} {T}_{R F}^{H} )}{{P}_{thr}} )}^{- \frac{1}{2}} , \qquad ( 17 )$$

where T_{RF} denotes the RF precoding matrix, \tilde{T}_{BB,x} denotes the equivalent baseband precoding matrix of the x-th subcarrier, (\tilde{T}_{BB,x})^{H} denotes a conjugate transpose of the equivalent baseband precoding matrix of the x-th subcarrier, and

$${T}_{R F}^{H}$$

denotes a conjugate transpose of the RF precoding matrix.

In some embodiments, the processor obtains a closed-form solution of the baseband precoder of the x-th subcarrier by differential operations. An expression of the closed-form solution of the baseband precoder is:

$${\tilde{T}}_{BB , x} = {( {T}_{R F}^{H} {\tilde{H}}_{1} {T}_{R F} + {σ}^{2} w {{P}_{thr}^{- 1} ( {H}_{B S}^{x} )}^{H} {T}_{R F}^{H} {T}_{R F} {H}_{B S}^{x} )}^{- 1} {T}_{R F}^{H} {H}_{1} , \qquad ( 18 )$$

where \tilde{H}₁ denotes a product of the equivalent G2A channel matrix H₁ and the conjugate transpose

$${H}_{1}^{H}$$

of the equivalent G2A channel matrix, and w denotes the trace of the product of the conjugate transpose (Rₓ)^{H} of the combining matrix and the combining matrix Rₓ.

In some embodiments,

$${\tilde{H}}_{1} {=}^{Δ} {H}_{1} {H}_{1}^{H} , and w = T r ( {( {R}_{x} )}^{H} {R}_{x} ) .$$

In some embodiments, the processor may obtain a rewritten MSE model by substituting the closed-form solution \tilde{T}_{BB,x} of the baseband precoder of the x-th subcarrier and the scaling factor βₓ for the given transmission power and noise power of the x-th subcarrier into the target function (16a) of the precoding design subproblem. An expression of a function of the rewritten MSE model with respect to the RF precoding matrix T_{RF} is:

$${J}_{x} ( {T}_{R F} ) = Tr {( {I}_{{N}_{s}} + \frac{{P}_{thr}}{{σ}^{2} w} {H}_{1}^{H} {T}_{R F} {Γ}_{x}^{- 1} {T}_{R F}^{H} {H}_{1} )}^{- 1} , \qquad ( 19 )$$

where Jₓ(T_{RF}) denotes the function of the rewritten MSE model with respect to the RF precoding matrix T_{RF}; Γₓ denotes the product of a conjugate transpose

$${( {H}_{B S}^{x} )}^{H}$$

of the channel matrix from the GS to the FSS system of the x-th subcarrier, a conjugate transpose matrix

$${R}_{R F}^{H}$$

of the RF combiner, the RF combining matrix R_{RF}, and the channel matrix

$${H}_{B S}^{x}$$

from the GS to the FSS system.

In some embodiments,

$${Γ}_{x} {=}^{△} {( {H}_{BS}^{x} )}^{H} {R}_{RF}^{H} {R}_{RF} {H}_{BS}^{x} .$$

In some embodiments, the processor simplifies and transforms the expression (5) of the MSE model into an optimization problem of the RF combining matrix R_{RF}. Expressions of the optimization problem of the RF combining matrix T_{RF} optimization problem are:

$${min}_{{T}_{RF}} {\sum }_{x = 0}^{X - 1} {J}_{x} ( {T}_{RF} ) ; \qquad ( 20 a )$$

$$s . t . \vert {[ {T}_{RF} ]}_{p , q} \vert = 1 , ∀ p , q . \qquad ( 20 b )$$

In some embodiments, in response to the non-convexity of the optimization problem due to the constant modulus constraints of the RF encoder as described above, the processor employs the MO algorithm to search for a step size of a gradient descent through the Armijo retracement line, and uses the step size to update the RF precoding matrix to obtain the final RF precoding matrix. The operation includes calculating the function Jₓ(T_{RF}) of the rewritten MSE model of the expression (19) with respect to the RF precoding matrix T_{RF} to obtain a Euclidean gradient ∇Jₓ(T_{RF}) corresponding to the RF precoding matrix T_{RF}; calculating a Riemannian gradient from the orthogonal projection of the Euclidean gradient ∇Jₓ(T_{RF}) on a tangent space; calculating a conjugate gradient direction: updating the RF precoding matrix T̅_{RF} using the step size of the gradient descent obtained by searching with the conjugate gradient direction and the Armijo retracement line; obtaining the final RF precoding matrix \hat{T}_{RF} by retracting the updated RF precoding matrix to the complex circle manifold.

Correspondingly, the above operation is also performed in solving the RF combining matrix R_{RF}.

The AO HBF-based interference suppression model refers to a model constructed based on the AO HBF interference suppression manner.

FIG. 3 is a schematic illustrating a structure of the AO HBF interference suppression model according to some embodiments of the present disclosure.

In some embodiments, the processor may construct the AO HBF-based interference suppression model to solve the beamforming matrix. As shown in FIG. 3, the AO HBF-based interference suppression model includes an RF precoder, a baseband precoder, a RF combiner, and a baseband combiner.

The RF precoder module is configured to solve the RF precoding matrix.

In some embodiments, the RF precoder module takes the combining matrix and the baseband precoding matrix as constants to obtain the expression (19) and performs the MO algorithm to solve the RF precoding matrix T_{RF}. Assume that the step size of the gradient descent obtained by the RF precoder at the j-th Armijo retracement line search is

$${γ}_{B}^{i , j} ,$$

and that the RF precoder at the j-th Riemannian gradient descent on the tangent space

$${∇}_{R} ( {J}_{x} ( {T}_{R F}^{i , j} ) )$$

is updated as:

$${\overline{T}}_{RF}^{i , j + 1} = {T}_{RF}^{i , j} - {γ}_{B}^{i , j} \frac{{∇}_{R} ( {J}_{x} ( {T}_{RF}^{i , j} ) )}{{‖ {∇}_{R} ( {J}_{x} ( {T}_{RF}^{i , j} ) ) ‖}_{F}} , \qquad ( 21 )$$

$$where$$

$${\overline{T}}_{RF}^{i , j + 1}$$

denotes an updated equation after (j+1)-th gradient descent in the i-th external iteration;

$${T}_{RF}^{i , j}$$

denotes the RF precoding matrix obtained from the j-th gradient descent in the i-th external iteration, and

$${γ}_{B}^{i , j}$$

denotes the step size obtained by the j-th gradient descent in the i-th external iteration,

$${∇}_{R} ( {J}_{x} ( {T}_{R F}^{i , j} ) )$$

denotes the Riemannian gradient of the RF precoding matrix

$${T}_{RF}^{i , j}$$

obtained from the J-th gradient descent in the i-th external iteration, and ∥

$${∇}_{R} ( {J}_{x} ( {T}_{R F}^{i , j} ) ) {‖}_{F}$$

denotes obtaining the Frobenius norm of the Riemannian gradient of the RF precoding matrix

$${T}_{RF}^{i , j} .$$

In some embodiments, the updated equation

$${\overline{T}}_{RF}^{i , j + 1}$$

after (j+1)-th gradient descent in the i-th external iteration is retracted to a complex circle manifold, and an expression is:

$${T}_{RF}^{i , j + 1} ( m , n ) = Retr ( {\overline{T}}_{RF}^{i , j + 1} ( m , n ) ) = \frac{{\overline{T}}_{RF}^{i , j + 1} ( m , n )}{\vert {\overline{T}}_{RF}^{i , j + 1} ( m , n ) \vert} , \qquad ( 22 )$$

$$where$$

$${\overline{T}}_{R F}^{i , j + 1} ( m , n )$$

denotes elements in the m-th row and n-th column of the update equation

$${\overline{T}}_{RF}^{i , j + 1}$$

of the RF precoding matrixed obtained by the (j+1)-th gradient descent in the i-th external iteration; Retr denotes a retraction operation;

$${\overline{T}}_{R F}^{i , j + 1} ( m , n )$$

denotes a modulus or the elements in the m-th row and n-th column of the update equation

$${\overline{T}}_{R F}^{i , j + 1} ; and {T}_{R F}^{i , j + 1} ( m , n )$$

denotes the elements of the m-th row and n-th column of the RF precoding matrix at the GS terminal obtained by (j+1)-th gradient descent in the i-th external iteration.

In some embodiments, an output of the iteration using the MO algorithm until the convergence of the i-th external iteration is the final RF precoding matrix

$${T}_{R F}^{i} .$$

The baseband precoder module is configured to solve the baseband precoding matrix.

In some embodiments, the baseband precoder module directly applies the closed-form solution to obtain the final baseband precoding matrix

$${T}_{BB , x}^{i} , ∀ x ∈ \{ 1 , … , X \}$$

after convergence of the i-th external iteration.

The RF combiner module is configured to solve the RF combining matrix.

In some embodiments, the RF combiner module is similar to the RF precoding module, and the RF combining matrix

$${R}_{R F}^{i , j + 1}$$

of the (j+1)-th gradient descent in the i-th external iteration is obtained by updating using the j-th gradient descent steps on the complex circle manifold, and the MO algorithm iterates until the i-th external iteration converges to output the RF combining matrix

$${R}_{R F}^{i} .$$

The baseband combiner module is configured to solve the baseband combining matrix.

In some embodiments, similar to the baseband precoder module, the baseband combiner module applies the closed-form solution to obtain the final baseband combining matrix

$${R}_{BB , x}^{i} , ∀ x ∈ \{ 1 , … , X \}$$

after convergence of the i-th external iteration.

In some embodiments, in order to improve the performance of the AO HBF-based interference suppression model, a fully-digital interference suppression hybrid beamforming is used in the initial setup.

In some embodiments, the training of the AO HBF-based interference suppression model includes the following operations.

In 1301, a transmitter-receiver beamforming matrix and the G2A channel matrix are initialized.

In 1302, a combining matrix at the receiver is fixed.

In 1303, the MO algorithm is executed to solve the transmitter RF precoding matrix

$${T}_{R F}^{i} .$$

In 1304, the baseband precoding matrix

$${T}_{BB , x}^{i}$$

is solved by using the closed-form solution.

In 1305, the precoding matrix at the transmitter is fixed.

In 1306, the MO algorithm is executed to solve the recover RF combining matrix

$${R}_{R F}^{i} .$$

In 1307, the baseband combining matrix

$${R}_{BB , x}^{i}$$

is solved by using the closed-form solution.

In 1308, whether the trained model converges is determined; in response to determining that the model converges, the training is ended, and the trained AO HBF-based interference suppression model is obtained; in response to determining that the model does not converge, operations 1302-1307 are repeated until the model converges.

In some embodiments, a final baseband precoding matrix

$${T}_{BB , x}^{I} ,$$

the RF precoding matrix

$${T}_{RF ,}^{I} ,$$

the baseband combining matrix

$${R}_{BB , x}^{I} ,$$

and the RF combining matrix

$${R}_{R F}^{I}$$

are obtained after the completion of the I-th external iteration.

In 140, anti-interference hybrid beamforming is obtained by using the AO HBF-based interference suppression model and the interference to the FSS system is reduced by using the anti-interference hybrid beamforming.

The anti-interference hybrid beamforming improves the signal-to-noise ratio of a user, reduces interference to coexisting systems (e.g., FSS), and approximates the performance of fully-digital beamforming under a finite RF chain.

FIG. 5 is a schematic diagram illustrating an exemplary process of constructing the AO HBF-based interference suppression model according to some embodiments of the present disclosure. In some embodiments, as shown in FIG. 5, an input of the AO HBF-based interference suppression model is the G2A channel matrix, and an output is the anti-interference hybrid beamforming.

In some embodiments, the processor may generate a baseband beamforming parameter and an RF beamforming parameter based on the anti-interference hybrid beamforming, control the antenna array to receive signals and/or transmit signals in an RF phase based on the RF beamforming parameter to form a fixed-direction beam, and control the antenna unit to receive and/or transmit signals in a unit amplitude and a unit phase based on the baseband beamforming parameter to accurately regulate each antenna unit, so as to realize the anti-interference hybrid beamforming.

The baseband beamforming parameter refers to a magnitude or a phase parameter that controls the antenna unit for receiving and/or transmitting signals. In some embodiments, the baseband beamforming parameter includes the unit amplitude and the unit phase for each antenna unit in the antenna array.

The RF beamforming parameter refers to an RF phase parameter that controls the antenna array for receiving signals and/or transmitting signals. In some embodiments, the RF beamforming parameter includes an RF phase.

In the embodiments of the present disclosure, “hybrid” refers to a combination of digital and analog beamforming, whereby analog beamforming allows the phase or amplitude of a signal to be adjusted using analog devices (e.g., a phase shifter, an attenuator) to form a fixed-direction beam, and all antenna units share a small count of RF chains (e.g., one RF chain may drive a plurality of antenna units), which may save cost and energy consumption. The unit amplitude and unit phase of each antenna unit are precisely tuned at the baseband through a digital signal processor (DSP) or FPGA through digital beamforming. With the anti-interference hybrid beamforming, it is possible to balance performance, complexity, and cost while reducing interference to FSS system.

In some embodiments, the processor may, at the preset intervals, obtain an interference power sequence of the antenna array to the FSS system, in response to determining that the interference power sequence does not satisfy a preset condition, re-obtain the anti-interference hybrid beamforming and generate an updated baseband beamforming parameter and an updated RF beamforming parameter, control the antenna array to receive signals and/or transmit signals in an updated RF phase based on the updated RF beamforming parameter to update a fixed direction of the beam, and control the antenna unit to receive and/or transmit signals in an updated unit amplitude and an updated unit phase based on the updated baseband beamforming parameter to perform precise regulation on each antenna unit, thereby re-obtaining of the anti-interference hybrid beamforming.

The interference power sequence refers to the interference power of the antenna array interfering with the FSS system at a plurality of moments in the last preset interval. In some embodiments, the processor may calculate to obtain the interference power at a plurality of moments to form the interference power sequence according to the expression (6b).

The preset conditions may include that the moment of the interference power in the interference power sequence exceeding the interference threshold Pₜₕᵣ does not exceed a preset quantity threshold. The preset quantity threshold may be set based on experience.

In some embodiments, in response to determining that the interference power sequence does not satisfy the preset condition, the processor may recalculate the anti-interference hybrid beamforming by using the AO HBF-based interference suppression model based on a distribution of the real G2A channel matrix in the previous preset interval, and generate the updated baseband beamforming parameter and the updated RF beamforming parameter based on the updated anti-interference hybrid beamforming.

In some embodiments, in response to determining that the interference power sequence satisfies the preset condition, the processor may precisely regulate each antenna unit according to the obtained anti-interference hybrid beamforming, thereby realizing the anti-interference hybrid beamforming.

In some embodiments of the present disclosure, determining whether to update the anti-interference hybrid beamforming by judging the interference power sequence and the preset condition may improve the accuracy of determining the anti-interference hybrid beamforming.

In embodiments of the present disclosure, accurate prediction accuracy may be obtained by the GAN-GRU G2A channel matrix prediction algorithm, and the AO HBF-based interference suppression model achieves a low MSE, which allows for accurate beamforming.

It should be noted that the foregoing description of the process 100 is for the purpose of exemplification and illustration only and does not limit the scope of application of the present disclosure. For those skilled in the art, various corrections and changes can be made to the process 100 under the guidance of the present disclosure. However, these corrections and changes remain within the scope of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about”, “approximate”, or “substantially”. For example, “about”, “approximate”, or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. An interference suppression method for a multi-antenna 5G aeronautical mobile airport communications system (AeroMACS) to a fixed satellite service (FSS) system, comprising:
constructing a minimum mean square error problem at a receiver under a maximum interference power constraint;
constructing a generative adversarial networks-gated recurrent unit (GAN-GRU)-based ground to air (G2A) channel matrix prediction model and obtaining a predicted G2A channel matrix by using the GAN-GRU-based G2A channel matrix prediction model;
constructing an alternating optimization hybrid beamforming (AO HBF)-based interference suppression model based on the predicted G2A channel matrix; and
obtaining an anti-interference hybrid beamforming by using the AO HBF-based interference suppression model and reducing interference to the FSS system using the anti-interference hybrid beamforming.

2. The interference suppression method of claim 1, wherein the constructing a minimum mean square error problem at a receiver under a maximum interference power constraint includes:
constructing a received signal model at an aircraft (AC) terminal of a subcarrier in a data transmission stage, wherein the received signal model includes a G2A GS-AC channel matrix of the subcarrier, a baseband precoding matrix of the subcarrier at a ground station (GS) terminal, a radio frequency (RF) precoding matrix at the GS terminal, a baseband combining matrix of the subcarrier at the AC terminal, and an RF combining matrix at the AC terminal; and
constructing a mean squared error (MSE) model based on the received signal model at the AC terminal of the subcarrier in the data transmission stage.

3. The interference suppression method of claim 2, wherein the GAN-GRU-based G2A channel matrix prediction model includes a GAN-based G2A channel data enhancement module and a GRU-based channel prediction module.

4. The interference suppression method of claim 3, wherein the GAN-based G2A channel data enhancement module includes a GAN input layer, a generative model, a discriminative model, a training model, and an evaluation model.

5. The interference suppression method of claim 4, wherein the GRU-based channel prediction module includes a GRU input layer, a GRU unit, and an output layer.

6. The interference suppression method of claim 2, comprising:
training the GAN-GRU-based G2A channel matrix prediction model by minimizing a loss function [symbol] _{GAN-GRU} of the GAN-GRU-based G2A channel matrix prediction model, an expression of the loss function being:
$${ℒ}_{G A N - GRU} = \{ \frac{{\sum }_{t = 1}^{L} {‖ {\hat{H}}_{B A}^{t} - {H}_{B A}^{t} ‖}^{2}}{{\sum }_{t = 1}^{L} {‖ {H}_{B A}^{t} ‖}^{2}} \} wherein {\hat{H}}_{B A}^{t}$$
denotes a predicted G2A channel matrix for a t-th frame of the GAN-GRU-based G2A channel matrix prediction model,
$${H}_{B A}^{t}$$
denotes a simulated G2A channel matrix for the t-th frame, [symbol] denotes a mean value symbol, and L denotes a total count of frames.

7. The interference suppression method of claim 1, wherein the AO HBF-based interference suppression model includes an RF precoder, a baseband precoder, an RF combiner, and a baseband combiner.
